(19) United States
(12) Patent Application Publication
(10) Pub. No.: US 2016/0348029 A1
(43) Pub. Date: Dec. 1, 2016

(54) System and method for forming a fragrant bead

(71) Applicant: Sven Dobler, Huntington, NY (US)

(72) Inventor: Sven Dobler, Huntington, NY (US)

(21) Appl. No.: 14/999,531

(22) Filed: May 19, 2016

Related U.S. Application Data
(60) Provisional application No. 62/230,267, filed on Jun. 1, 2015.

(51) Int. Cl. C11B 9/00; C08L 1/02; C08L 47/00

(52) U.S. Cl. CPC C11B 9/00; C08L 47/00; C08L 1/02

(57) ABSTRACT

A system for forming a fragrant bead is disclosed which comprises a first container for mixing a fragrance with a polymer into a mixture, the first mixing container having a dispensing system for dispensing the mixture, and a second container for containing a surplus amount of cross-linker and for receiving the mixture dispensed from the first container, the surplus amount of cross-linker for reacting with the mixture to form a fragrant bead.

### CROSS REFERENCE TO RELATED APPLICATIONS

This non-provisional patent application claims priority to the provisional patent application having Ser. No. 62/230,267, filed on Jun. 1, 2015.

### FIELD OF THE DISCLOSURE

This disclosure relates to a system and method for forming a fragrant bead that may be used to deliver a fragrance into the air or atmosphere.

### BACKGROUND

Various devices are available for releasing a fragrance into the air. In air freshening, laundry, and other industrial or consumer product applications surface area is a key component for releasing a fragrance into the air and ambient atmosphere. The load weight or concentration of the component sought to be released from a containment material is also important. The higher the concentration the easier the containment material will release the component. Also, the smaller the size of the containment material the more rapidly the fragrance will be released. Some fragrance releasing products are of gel products that are used mostly for toys, novelties, gifts, window clings, and decorative ornaments. Consumers are particularly attracted by the gel products due to their features of softness, color, and introduction of a scent or fragrance.

A fragrant gel product results from the cross-linking between a functionalized polymer and a cross-linking agent, both generally liquid in the presence of a single or a multiple part fragrance base. The polymer cross-links in the presence of the fragrance to form a gel which encloses the perfume, or fragrance. The gel can form in a recess in a substrate as an air freshener device, as a block, and the like.

While mixing, the fragrance, polymer, and cross-linking agent forms a practical homogeneous mixture, such a mixture poorly controls the flow of the cross-linking agent in a small volume. For a better gel product, equalizing the flow rates of the different premixes into the final mixing step has had more positive results. Accordingly, the fragrance acquires a formulation by conventional methods and then a portion of the fragrance mixes with the polymer and the remainder of the fragrance mixes with the cross-linking agent. The two mixtures can then be mixed together to form a mixture that gels. As the fragrance remains separated within the two mixtures, the mixture containing the cross-linking agent has a greater volume than the volume of the cross-linking agent alone, and therefore a greater flow rate, more easily controlled.

Though this mixture method works well when the production line starts, the gel produced by the mixture method worsens after the production line has run for a time. The gelling time of the mixture, i.e. the time required for a non-flowing gel to form into a shape, tends to rise over time. This longer forming time causes problems into the manufacturing shift, especially at the end of a shift, on an operating machine. For example, if the gelling time of the mixture increases and exceeds the time that the containers, containing the fragrance elements, occupy the production line, the gel may have partially solidified and may retain some liquid when the containers, or forms, are removed from the production line. This liquid can spill from the forms, or containers, leading to waste of ingredients, disruption of the production line for cleaning, and release of spilled ingredients into the local sewage system.

Fragrances usually contain components which react with either, or both, of the functionalized polymer and the cross-linking agent. The prior art processes have the functionalized polymer and cross-linking agent each mixing with different parts of the fragrance, before the polymer and the cross-linking agent are mixed. Thus, the functionalized polymer and cross-linking agents mix with separate fragrance components, not the same fragrance composition. Instead, the gel product has a final fragrance composition arranged, and different components of the composition are then mixed with the functionalized polymer and with the cross-linking agent. By separating the fragrance components, the issue of incomplete gel formation decreases to a practical extent or even completely ceases.

While the precise ingredients of any particular fragrance often remain trade secrets, the typical classes of ingredients and particularly common ingredients include volatile compounds such as esters, alcohols, aldehydes and ketones. As before, the functionalized polymers and cross-linking agents react with certain fragrance ingredients but not others. The reaction rate may be relatively slow and that does not appear early in a manufacturing shift but, after the fragrance ingredients have been mixed with the functionalized polymer and cross-linking agent for some time, a few hours in many cases, some of the fragrance components will have reacted as a pre-reaction. Alas, these pre-reactions may undesirably affect the fragrance, varying its fragrance over a production run. Furthermore, the pre-reactions consume some of the functionalized polymer and cross-linking agent, thus reducing the concentration of reactive sites of the functionalized polymer and the cross-linking agent later in the production run. The pre-reactions have an often increased setting time using prior art methods and processes.

The functional polymer has one or more functional groups while the cross-linking agent has one or more complementary functional groups. The mixture of these two provides, in the presence of a fragrance base, a reaction product that encloses the fragrance base in a gel product which then emanates the fragrance to the atmosphere to freshen the air. Suitable functional groups include carboxylic acid, anhydride or acid chloride groups, amines, and alcohols. The functional polymer forms by adding a functional group to any polymer capable of functionalization, or the polymer itself inherently contains functional groups. The functional groups can be pendent on the main chain perhaps with intervening spacer groups or in the main chain. Preferred polymers for functionalization include polyolefins, particularly those derived from mono-olefins or di-olefins containing, at least one vinyl group.

The cross-linking agent generally dissolves in the fragrance base. Suitable cross-linking agents include dihydroxy polybutadiene, alkoxylated primary amines, alkylpropyldiamines having an ethoxylated or propoxylated fatty aliphatic chain, diethanolamine, diethylenetriamine, polyoxyalkylenediamines and alkoxylated primary fatty amines. The cross-linking agent may have one or more diamines or triamines, polyoxyalkylene amines, polyethoxy diamines and triamines, polypropoxy diamines and triamines.

It is known that the fragrance is a mixture of volatile liquid ingredients of natural or synthetic origin. List and descriptions of the ingredients appear in perfumery books, for example in S. Arctander, Perfume and Flavour Chemicals, Montclair, N.J., USA, 1969, and the like. The art of formulating a fragrance begins with devising a base and at least a note having the desired fragrance, generally a common task carried out by a fragrance manufacturer.

Generally, the cross-linking agent reacts with some of the fragrance components, while the functionalized polymer does not appreciably react during a typical production shift. The prior art separates the components of a fragrance into those components of the fragrance which react, or are likely to react, with the cross-linking agent and those components which do not react, or are unlikely to react. Individual fragrance components which do not react with either the functionalized polymer or the cross-linking agent may be mixed with either polymer or cross-linking agent at the discretion of the fragrance manufacturer.

One known gel process is disclosed in U.S. Pat. No. 6,846,491 which issued to Richards. This patent describes a clear polymeric gel of cross-linked polymers. For instance, the polymers include Lithene®, from Struktol Co. of America, Stow, Ohio, distributor for Synthomer® of the United Kingdom for Phase 1 and Jeffamine®, by Huntsman® Corp. of Salt Lake City, Utah for Phase 2. The fragrance begins as fragrant oil formulations of both organic and inorganic aroma chemicals along with other ingredients used to prepare fragrances. The fragrant oil formulations are blended with both Lithene® and Jeffamine® generally and with a surfactant such as Steol® by Stepan® Co. of Chicago, Ill. The fragrance oils pre-mix readily in Phases 1 and 2, thus making each phase homogeneous and fostering ready combination and mixture of Phases 1 and 2. The Richards method entraps the active aroma chemicals and produces a solid gel in less than 45 minutes. The Richards method also avoids the heat dependent formulations or those created at room temperature as known in the art. The heat dependent formulations run the risk of altering, modifying, or destroying the fragrance oils when the volatile organic compounds within the fragrance oils evaporate or break down.

Additionally, the polymers used by Richards have some high reactivity and react early with colorants and pigments during gel manufacturing. The polymers tend to lessen the ability of gels to remain color fast and in time, the gels lose their color. The polymers also react with aromatic chemicals in fragrance oil formulations thus partially depleting the aromatic chemicals before mixing with other fragrance components. The depleted aromatic chemicals lead to imperfect cross-linking of Lithene® and Jeffamine® polymers where the fragrance oils later precipitate from the gel, as in syneresis, or the gel becomes unstable, liquefies, and fails. Formulating fragrances for the Richards method has challenged manufacturers who have faced limits upon usage of fragrance components when creating various cosmetic products. In a few case, manufacturers have been thwarted in combining certain fragrances with gels. Further, the Richards method has a long manufacturing time.

A second gel process is disclosed in U.S. Pat. No. 7,132,461 that issued to O'Leary et al. O'Leary applies to a method of manufacturing fragrance oils making a fragrant gel in two parts. The O'Leary method splits the fragrance oils into two parts, the polymer reactive and the cross-linking agent reactive, such as Lithene® and Jeffamine® respectively. In splitting the oils, each element of a fragrance formulation requires testing for reactivity to various polymers for segregation into polymer and cross-linking agent reactive components. Generally, the polymer reactive parts are blended with cross-linking agent as Phase 1 while the cross-linking agent reactive parts are blended with polymer as phase 2. To form the complete fragrance, the two phases are blended and provide more effective cross-linking of polymers because the reactive sites of each polymer have not already reacted with the fragrance components known to favor that polymer. In blending the two phases, the fragrance components assemble and make the whole fragrance as desired by the consumer. The O'Leary method reduces syneresis and shrinkage of the gel product while improving the stability of the finished gel product. However, the O'Leary method is very complicated and time consuming.

The present disclosure overcomes the disadvantages and limitations of the prior art. In particular, a system for forming a fragrant bead is disclosed herein in which fragrant beads may be quickly and easily formed. The present disclosure provides for a fragrance oil to be blended or mixed with a polymer and then the mixture is dispensed (“prilling”) into a surplus amount of cross-linker to quickly form fragrant beads. Another system for forming fragrant beads by adding a fragrance formulation into a quantity of pre-formed cellulose beads is also disclosed in which fragrant beads are quickly and easily formed by dosing or spraying fragrance oil on the containment material of the formed cellulose beads.

### SUMMARY

In one form of the present disclosure, a system for forming a fragrant bead is disclosed which comprises a first container for mixing a fragrance with a polymer into a mixture, the first mixing container having a dispensing system for dispensing the mixture, and a second container for containing a surplus amount of cross-linker and for receiving the mixture dispensed from the first container, the surplus amount of cross-linker for reacting with the mixture to form a fragrant bead.

In another form of the present disclosure, a method for forming a fragrant bead is disclosed which comprises the steps of mixing a fragrance with a polymer together in a first container to form a mixture and dispensing the mixture into a second container containing a surplus amount of a cross-linker for the mixture to react with the surplus amount of cross-linker to form a fragrant bead.

In still another form of the present disclosure, a system for forming a quantity of fragrant beads is disclosed which comprises a first mixing container for mixing a fragrance formulation, the first mixing container further having a conduit for dispensing the fragrance formulation and a second mixing container being filled with a quantity of formed cellulose beads, the second mixing container for receiving the fragrance formulation for applying the fragrance formulation on the cellulose beads for forming a quantity of fragrant beads.

In light of the foregoing comments, it will be recognized that the present disclosure provides a system and method for forming a fragrant bead that is capable of releasing a fragrance into the atmosphere.

The present disclosure provides a system and method for forming a fragrant bead where a smaller bead is capable of releasing a fragrance more rapidly as compared to a larger bead or an extruded bead or a molded bead.

The present disclosure is also directed to a system and method for forming a fragrant bead in which a small sized bead is capable of releasing a more intense fragrance than a larger bead due to increased surface area.

The present disclosure also provides a system and a method for forming a fragrant bead in which the fragrant bead is capable of being formed within a few seconds.

The present disclosure is directed to a system and a method for forming a fragrant bead which may be a component part of an air freshener.

The present disclosure provides a system and a method for forming a fragrant bead which produces a stable fragrant bead.

The present disclosure is directed to a system and a method for forming a fragrant bead by adding a fragrance formulation into a quantity of formed cellulose beads in which fragrant beads are quickly and easily formed on the containment material of the formed cellulose beads.

The present disclosure is also directed to a system and method for forming fragrant beads that may be easily and efficiently be manufactured and marketed at less cost than existing fragrance samplers.

The present disclosure also provides a system and method for forming fragrant beads that have increased surface area to release more fragrance than a comparable weight of a traditionally formed carrier or containment material.

These and other advantages of the present disclosure will become more apparent to those skilled in the art after considering the following detailed specification in conjunction with the accompanying drawings.

### BRIEF DESCRIPTION OF THE DRAWINGS

FIG. 1 is a block diagram of a system for manufacturing a fragrant bead constructed according to the present disclosure; and

FIG. 2 is a block diagram of another system for manufacturing a fragrant bead constructed according to the present disclosure.

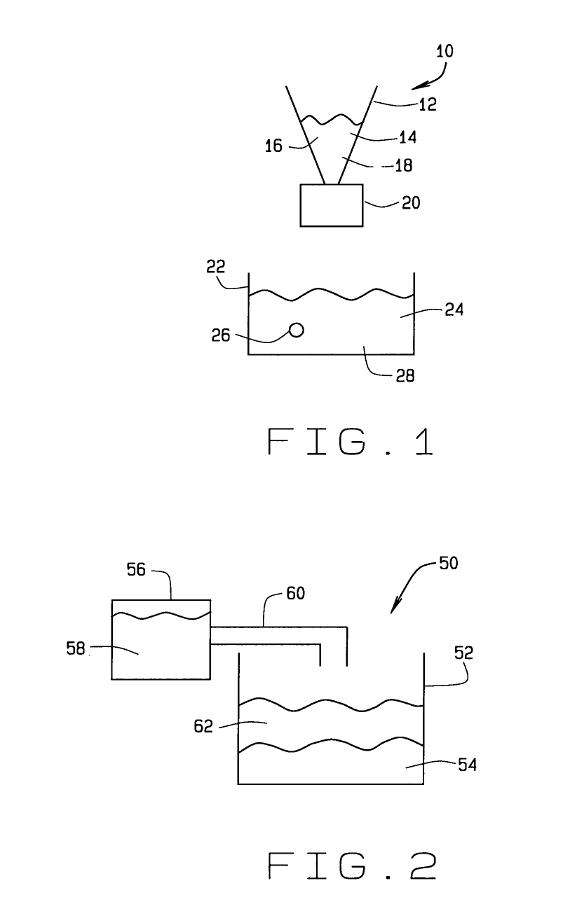

### DETAILED DESCRIPTION OF PREFERRED EMBODIMENTS

Referring now to the drawings, wherein like numbers refer to like items, number 10 identifies a preferred embodiment of a system for forming or manufacturing a fragrant bead constructed according to the present disclosure. The system 10 has a first container 12 for mixing a quantity of a fragrance oil or a fragrance formulation 14 with a polymer 16 into a mixture 18. The fragrance formulation 14 is selected by a fragrance house or manufacturer and may have as many components as determined by a designer or a chemist of the fragrance house that are mixed together in the first container 12. The fragrance formulation 14 is typically in a liquid state. The first container 12 has a dispensing system 20, such as a nozzle, static mixer, pipette or other similar dosing system or “prilling” system that drops or sprays the mixture 18 of the fragrance formulation 14 and the polymer 16 into a second container 22. The second container 22 has a surplus amount of a cross-linker 24 therein that reacts with the mixture 18 of the fragrance 14 and the polymer 16. This results in an immediate reaction that forms a solid or semi-solid gel 26 within the second container 22 typically within seconds. The density and specific gravity of the polymer 16 should be greater than the cross-linker 24. Given the higher specific gravity of the mixture 18 of the fragrance formulation 14 and the polymer 16 than the cross-linker 24, a droplet or bead or amorphous solid or semi-solid gel 26 will be formed in the second container 22. The bead 26 will settle to a lower area 28 of the second container 22. Varying sizes and shapes of the gel 26 can be created depending on the size and volume of the dispensing system 20. For example, the dispensing system 20 may have a nozzle (not shown) of a certain size to produce one or more beads 26 of a certain size. The mixture 18 of the fragrance formulation 14 and the polymer 16 will immediately react with the surplus cross-linker 24 and will precipitate in the second container 22 from which the beads 26 can be strained or easily separated when the second container 22 is filled with a sufficient amount of the beads 26.

The beads 26 can be easily packaged in a larger variety of packaging materials or containers since the containers do not have to contain materials that are liquid and or heated in their original state. Some examples of containers or packages that can contain the beads 26 are non-woven pouches, paper cartons, injection molded containers, thermally formed containers, blisters, or shells, paper envelopes, flexible film pouches, packets, ceramic containers and pomanders, warmers and plug in air fresheners, and tins. To facilitate packaging of the gel beads 26, a desiccant or flow control additive such as silicone may be added to the beads 26 so that the beads 26 can dispense, flow, or be handled more easily during packaging operations.

The polymer 16 and the mixture 18 in the first container 12 may also include an alcohol. The surplus amount of the cross-linker 24 may also include water and non-reactive fragrance. Surplus means far more than is required for the chemical cross-linker 24 to react with the polymer 16. When the mixture 18 is dispensed into the second container 22, an almost immediate reaction occurs between the mixture 18 and the cross-linker 24 to form the solid or semi-solid bead 26. This reaction typically occurs within seconds. As previously indicated, the density and specific gravity of the polymer 16 should be greater than the cross-linker 24. The system 10 may also include a heated gel system (not shown). In the case of a heated gel system, the second container 22 can be cooled to allow faster formation and cooling of the beads 26.

The polymer 16 derives from butadiene, isoprene or chloroprene. Preferably the polymer 16 is maleinized polybutadiene of at least 5000 molecular weight. Alternatively, the polymer 16 includes maleinized polyisoprene of at least 200,000 molecular weight. These polymers 16 are readily available from commercial chemical sources. A preferred polymer 16 is Lithene® by Synthomer®, typically Lithene® N4-9000 10MA, which is a maleinized polybutadiene of a 9000 molecular weight before maleinization.

By way of example only, the mixture 18 of the fragrance formulation 14 and the polymer 16 may be a batch that is 61% fragrance, 27% Lithene N4-9000-10 MA, 5.% alkoxylated neopentyl glycol, and 7% Stepantex VT 90. This mixture may also contain MSS-500, which is an odorless, spherical shaped white powder made by Kobo Products, Inc. Again, by way of example only, a batch size of 205 pounds would consist of 125.1 pounds of fragrance, 55.4 pounds of Lithene N4-9000-10 MA, 10.3 of alkoxylated neopentyl glycol, and 6,514.90 grams of Stepantex VT 90. Further, a 400 pound batch would consist of 244 pounds of fragrance, 108 pounds of Lithene N4-9000-10 MA, 20 pounds of alkoxylated neopentyl glycol, and 12,712 grams of Stepantex VT 90. Further, the mixture 18 of the fragrance formula 14 and the polymer 16 may be in the following ranges: Fragrance 50-95%; Lithene 5-40%; alkoxylated neopentyl glycol 0-10%; Stepantex VT 90 0-10%; and MSS 500 0-2%.

The cross-linker 24 comes from the amine family of polymers, including polypropoxy diamines, polypropoxy triamines and polyethoxydiamines. A preferred cross-linker 24 is Jeffamine® by Huntsman® Corp., such as the Jeffamine-T 403 and Jeffamine-XTJ 506, which are polyetheramine. By way of example only, a batch of the cross-linker 24 may consists of 10% of fragrance, 25% of Jeffamine-T 403, 10% of Jeffamine-XTJ 506, 50% of ethyl alcohol SD39, and 5% of Steol CS 460. A 205 pound batch of the cross-linker 24 would consist of 20.5 pounds of fragrance, 51.3 pounds of Jeffamine-T 403, 20.5 pounds of Jeffamine-XTJ 506, 102.5 pounds of ethyl alcohol SD39, and 10.3 pounds of Steol CS 460. Also, a 400 pound batch of the cross-linker 24 would consist of 40 pounds of fragrance, 100 pounds of Jeffamine-T 403, 40 pounds of Jeffamine-XTJ 506, 200 pounds of ethyl alcohol SD39, and 20 pounds of Steol CS 460. Further, the cross-liner 24 may be in the following ranges: Fragrance 0-10%; Jeffamine-T 403 0-40%; Jeffamine-XTJ 506 0-30%; ethyl alcohol 1-75%; and Steol CS 460 0-5%.

As can be appreciated, during the forming process, as outlined above, a fragrance 14 can be placed or inserted into the first container 12 and may contain a single polymer 16 or a combination of multiple polymers where the single polymer 16 or the combination of polymers can be from 1-90% of the weight of a first phase of the manufacturing process. The first phase of the manufacturing process is accomplished in the first container 12. Single polymer 16 or a combination of polymers can be anhydride functionalized polymers including maleinized polybutadiene polymer. Other polyamide polymer can also be used as single or in combination with other polyamide polymer. The second container 22 may contain a single type cross-linker 24 or a combination of multiple cross-linkers where the single cross-linker 24 or the combination of cross-liners can be from 1-90% of the weight of a second phase of the manufacturing process. The second phase of the manufacturing process is accomplished in the second container 22. Cross-linker 24 or a combination of cross-linkers can be monoamines, polyamine or class of polyehteramines. Other cross-linker agents can also be Isocyanates class. Other components such as hydrophobic or hydrophilic components as coadjutors to help processing function can be added into one or both of the phases.

It is critical that the density of the first phase cannot be the same as the second phase. The two phases can be processed with other hydrophilic and/or hydrophobic components separately then combined one phase into the other phase through a mechanical or a control electronic device which form an individual round droplet. The droplet will be submerged into the second phase where chemicals cross-link occur rapidly to form a rounded gel bead that contains hydrophobic and/or hydrophilic components that are trapped within the gel bead. Further, a small sized gel bead typically dissipates an intense fragrance rapidly while a large sized gel bead will dissipated a fragrance slowly. Also, fragrance released from rounded or oval shaped beads will be much more intense than compared to a flat piece of gel having the same weight. Gel beads can be used to provide a controlled delivery a fragrance.

The mixture 18 and the cross-linker 24 may include other additives, such as water, alcohols, surfactants, pigments, colorants, and even additional fragrances for various reasons, such as modifying the specific gravity of the mixture 18 to be greater than the specific gravity of the cross-linker 24, or modifying texture, hardness, shape, and form of the beads 26.

Referring now to FIG. 2, another system for forming a fragrant bead 50 constructed according to the present disclosure is shown. The system 50 has a first container 52 filled with formed cellulose beads 54 and a second container 56 filled with a fragrance formulation 58. The second container 56 is capable of delivering the fragrance formulation 58 to the first container 52 via a pipe, conduit, or tubing 60. The fragrance formulation 58 is mixed with the cellulose beads 54 to form fragrant beads 62. The fragrant beads 62 provide a controlled delivery of the fragrance formulation 58. By way of example only, the mixture of the cellulose beads 54 and the fragrance formulation 58 may be in the following ranges: Cellulose beads 65-95%; and Fragrance formulation 0-35%.

Cellulose is derived from plants and trees and beads can be carved, cut, shaped, or formed from the naturally occurring structures and shapes of cellulose. However, wood cellulose contains bonding agents such as lignin and the fibers are oriented directionally which makes the loading, absorption, and release of fragrances more difficult and time consuming. To optimize the ability of cellulose beads to effectively absorb and release a fragrance, it is recommended to mill or grind the cellulose to a powder or flour and form beads from a slurry created from the powder or flour together with water or other evaporating solvent and starch. This can be accomplished by spraying the cellulose slurry on to a solid center, such as a kernel of sand, seed, pellet, or other solid or semi-solid center while tumbling slowly to build up the circumference of the kernel. In this manner, the cellulose beads 54 are formed or manufactured prior to being deposited into the first container 52.

The cellulose beads 54 provide a containment material for the fragrance formulation 58. Since the cellulose beads 54 do not have directionally oriented fibers, the cellulose beads 54 have superior absorption and release properties when the fragrance formulation 58 are applied. The surface area associated with each of the fragrant beads 62 is greater than the surface area provided by comparable weight traditionally formed flat cellulose carrier materials such as a paper card. The cellulose beads 52 may also have add other components such as laundry softeners, anti-static chemicals, brightening agents, odor eliminating chemicals, conditioners, and absorbing components.

The fragrant beads 62 can be easily packaged in a large variety of packaging materials or containers since the containers do not have to contain materials that are liquid and or heated in their original state. Some examples of containers or packages that can contain the beads 62 are non-woven pouches, paper cartons, injection molded containers, thermally formed containers, blisters, or shells, paper envelopes, flexible film pouches, packets, ceramic containers and pomanders, warmers and plug in air fresheners, and tins.

From all that has been said, it will be clear that there has thus been shown and described herein a system and method for forming a fragrant bead. It will become apparent to those skilled in the art, however, that many changes, modifications, variations, and other uses and applications of the subject system and method for forming a fragrant bead are possible and contemplated. All changes, modifications, variations, and other uses and applications which do not depart from the spirit and scope of the disclosure are deemed to be covered by the disclosure, which is limited only by the claims which follow.

What is claimed is:

1. A system for forming a fragrant bead comprising:
a first container for mixing a fragrance with a polymer into a mixture, the first mixing container having a dispensing system for dispensing the mixture; and
a second container for containing a surplus amount of cross-linker and for receiving the mixture dispensed from the first container, the surplus amount of cross-linker for reacting with the mixture to form a fragrant bead.

2. The system for forming a fragrant bead of claim 1 wherein the polymer has a density and a specific gravity, the cross-linker has a density and a specific gravity, and the density and the specific gravity of the polymer is greater than the density and the specific gravity of the cross-linker.

3. The system for forming a fragrant bead of claim 1 wherein the polymer is derived from butadiene, isoprene or chloroprene.

4. The system for forming a fragrant bead of claim 1 wherein the polymer comprises maleinized polyisoprene of at least 200,000 molecular weight.

5. The system for forming a fragrant bead of claim 1 wherein the polymer is Lithene® N4-9000 10MA, which is a maleinized polybutadiene of a 9000 molecular weight before maleinization.

6. The system for forming a fragrant bead of claim 1 wherein the cross-linker comes from the amine family of polymers, including polypropoxy diamines, polypropoxy triamines and polyethoxydiamines

7. The system for forming a fragrant bead of claim 1 wherein the cross-linker is Jeffamine-T 403 or Jeffamine-XTJ 506.

8. The system for forming a fragrant bead of claim 1 wherein the mixture of the fragrance and the polymer may be a batch that is 61% fragrance, 27% Lithene N4-9000-10 MA, 5.% alkoxylated neopentyl glycol, and 7% Stepantex VT 90

9. A method for forming a fragrant bead comprising the steps of:
mixing a fragrance with a polymer together in a first container to form a mixture; and
dispensing the mixture into a second container containing a surplus amount of a cross-linker for the mixture to react with the surplus amount of cross-linker to form a fragrant bead.

10. The method for forming a fragrant bead of claim 9 further comprising the step of providing a dispensing system for the first container.

11. The method for forming a fragrant bead of claim 9 further comprising the step of adding alcohol to the second container to mix the alcohol with the mixture.

12. The method for forming a fragrant bead of claim 9 further comprising the step of adding water to the container containing the surplus amount of the cross-linker.

13. The method for forming a fragrant bead of claim 9 wherein the polymer is derived from butadiene, isoprene or chloroprene.

14. The method for forming a fragrant bead of claim 9 wherein the polymer comprises maleinized polyisoprene of at least 200,000 molecular weight.

15. The method for forming a fragrant bead of claim 9 wherein the cross-linker comes from the amine family of polymers, including polypropoxy diamines, polypropoxy triamines and polyethoxydiamines

16. A system for forming a quantity of fragrant beads comprising:
a first mixing container for mixing a fragrance formulation, the first mixing container further having a conduit for dispensing the fragrance formulation; and
a second mixing container being filled with a quantity of formed cellulose beads, the second mixing container for receiving the fragrance formulation for applying the fragrance formulation on the cellulose beads for forming a quantity of fragrant beads.

17. The system for forming a quantity of fragrant beads of claim 16 wherein the quantity of formed cellulose beads are formed by grinding cellulose into a powder, forming a slurry by combining the powder and water, and spraying the slurry onto a solid center.

18. The system for forming a quantity of fragrant beads of claim 16 wherein the mixture of the cellulose beads and the fragrance formulation is in the ranges of cellulose beads 65-95% and fragrance formulation 0-35%.

19. The system for forming a quantity of fragrant beads of claim 16 wherein the second mixing container may further have added therein other components such as laundry softeners, anti-static chemicals, brightening agents, odor eliminating chemicals, conditioners, and absorbing components

20. The system for forming a quantity of fragrant beads of claim 16 wherein the quantity of formed cellulose beads are formed by grinding cellulose into a powder, forming a slurry by combining the powder and water, and spraying the slurry onto a solid center, and tumbling the solid center during spraying of the slurry to build up coating of the solid center with the slurry.
